(19) United States
(12) Patent Application Publication
(10) Pub. No.: US 2013/0102394 A1
(43) Pub. Date: Apr. 25, 2013

(54) Location Enabled Gaming

(71) Applicants: Lynne Seitz, Seattle, WA (US); Farhad Kasad, Bothell, WA (US)

(72) Inventors: Lynne Seitz, Seattle, WA (US); Farhad Kasad, Bothell, WA (US)

(21) Appl. No.: 13/645,961

(22) Filed: Oct. 5, 2012

Related U.S. Application Data
(60) Provisional application No. 61/544,356, filed on Oct. 7, 2011.

(51) Int. Cl. G07F 17/32

(52) U.S. Cl. CPC G07F 17/3225
USPC 463/42

(57) ABSTRACT

Location-restricted games are enabled on wireless devices, and even personal computers, to participate online in location-restricted games such as lottery if verified to be physically present in the relevant geographic area. The location-enabled gaming device forces or otherwise triggers a network based secure location request to find the current geographic location of the gaming device on which the location-restricted game is attempted to be played. A request is periodically triggered for a fresh current geographic location of the location-enabled gaming device, to permit the location-enabled gaming device to continue to operate the location-restricted game application as being still within an acceptable or otherwise authorized geographic location. Failure to receive a response to a location request, or in required accuracy, results in termination of the location-restricted gaming application.

The present application claims priority from U.S. Prov. No. 61/544,356, entitled “Location Enabled Gaming”, filed Oct. 7, 2011, the entirety of which is expressly incorporated herein by reference.

### BACKGROUND OF THE INVENTION

1. Field of the Invention

This invention relates generally to mobile communications devices. More particularly, it relates to location based systems (LBS) gaming applications in wireless devices (e.g., VoIP, cellular).

2. Background of Related Art

A lottery is a form of gambling which involves the drawing of lots for a prize. Lottery is regulated by the respective states in which it is played. Due to state or regulatory laws a person can participate in local games (e.g. a lottery) only if they are physically within that state's geographic area. Out of state participants must physically drive to the state or other regulated region to participate in a regulated game.

### SUMMARY OF THE INVENTION

In accordance with the principles of the present invention, a method and apparatus for administering a location-restricting game application over a network, comprises receiving a game-initiation request from a gaming device requesting participation in a location-restricted game application. A current location of the gaming device is requested in response to receipt of the game-initiation request. It is determined if the gaming device is currently within an authorized geographic area in which the requested game may be permissibly played. If the gaming device is within the authorized geographic area, the game-initiation request is authorized.

### BRIEF DESCRIPTION OF THE DRAWINGS

Features and advantages of the present invention will become apparent to those skilled in the art from the following description with reference to the drawings, in which:

FIG. 1 shows exemplary message flow for a location-enabled gaming device operating a location-restricted game application, when the location-enabled gaming device is operated when within a permissible geographic area for the location-restricted game application to be played, in accordance with the principles of the present invention.

FIG. 2 shows exemplary message flow for a location-enabled gaming device operating a location-restricted game application, when the location-enabled gaming device is attempted to be operated when outside a permissible geographic area for the location-restricted game application to be played, in accordance with the principles of the present invention.

### DETAILED DESCRIPTION OF ILLUSTRATIVE EMBODIMENTS

The present invention provides a location based device to enable mobile gaming for games which are restricted to be played only in certain geographic area(s) due to state or regulatory laws. With a location enabled gaming device in accordance with the present invention, a person can purchase or play a location-restricted game only when the location enabled gaming device (e.g., a smart phone) is physically in the required geographic region. This enables a segment of gaming on mobile/hand held devices, and even personal computers, which currently can't be used to participate in location-restricted games such as lottery because of legal restrictions of the relevant states.

There currently is no method to independently authenticate either a precise or coarse location of where a person is located when gaming.

In accordance with the principles of the present invention, when a location-restricted game is activated on a relevant wireless device (or personal computer) (aka location-enabled gaming device), the location-enabled gaming device forces or otherwise triggers a network based secure location request to find the current geographic location of the gaming device on which the location-restricted game is attempted to be played.

If the accuracy of the returned geographic location is not sufficiently detailed or otherwise acceptable, an additional location method may be initiated. For instance, location may be requested from an onboard global positioning system (GPS) device, if enabled. Ultimately, a returned geographic location must be within a permissible geographic area to permit the location-restricted gaming application on the location-enabled gaming device (e.g., a wireless phone or smart phone) to proceed to be played.

Preferably the location-restricted gaming application periodically, intermittently, or otherwise occasionally triggers a request for a fresh current geographic location of the location-enabled gaming device, to permit the location-enabled gaming device to continue to operate the location-restricted game application. Thus, while the user of the wireless location-enabled location device is in the act of running a relevant location-restricted game application, the location-enabled gaming device will periodically or otherwise check on occasion to authenticate that the location-enabled gaming device (and thus presumably also the user per the relevant gaming laws and regulations) is still within an acceptable or otherwise authorized geographic location.

Preferably any failure to receive a response to a location request, or failure in a required accuracy of the returned geographic location, will preferably result in termination of the location-restricted gaming application on the wireless device.

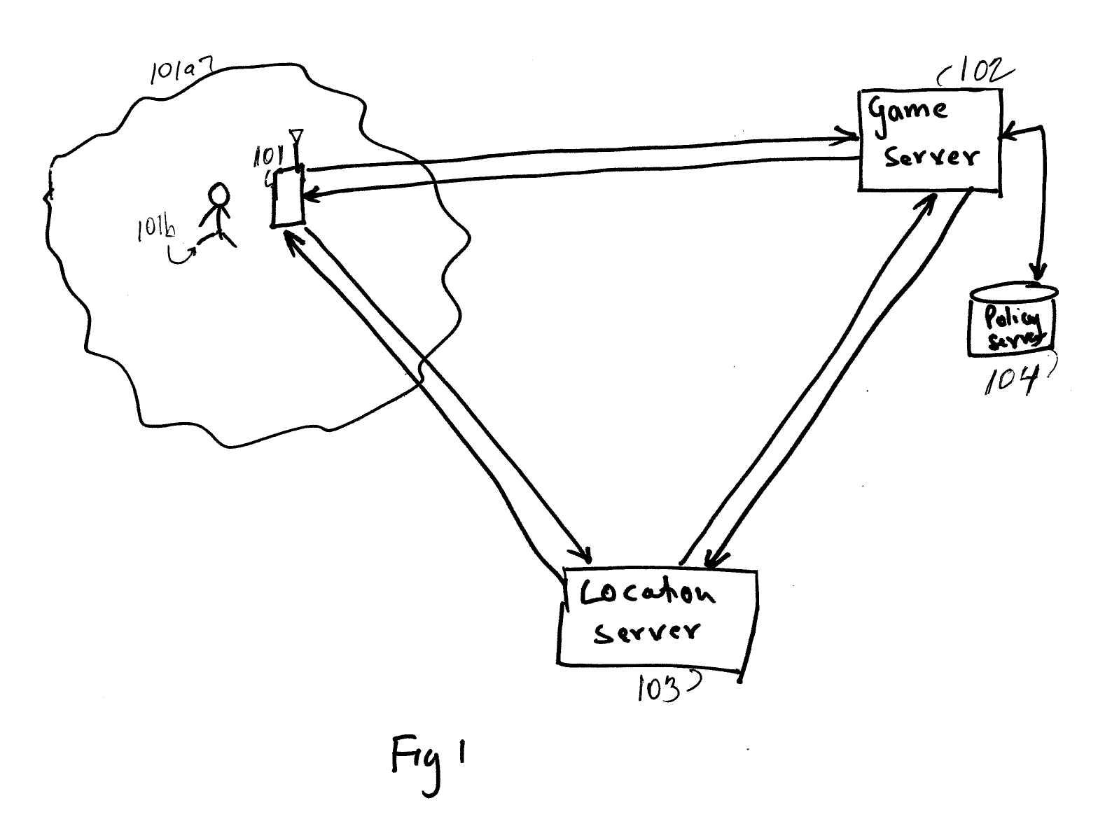

FIG. 1 shows exemplary message flow for a location-enabled gaming device operating a location-restricted game application, when the location-enabled gaming device is operated within a permissible geographic area for the location-restricted game application to be played, in accordance with the principles of the present invention.

In particular, as shown in FIG. 1, a location-restricted gaming device 101 is in wireless communication with an Internet-based game server 102 to participate in a given location-restricted gaming application (e.g., a lottery game, gambling, etc.) running on the location-enabled gaming device 101. The Internet-based game server 102 is also in communication with a location server 103, e.g., via the Internet.

Preferably the Internet-based game server 102 is also in communication with a policy server 104 to implement predetermined location-based restrictions for use of a given location-restricted gaming application (or games) facilitated by the game server 102.

When a user 101b of the wireless location-enabled gaming device 101 initiates a location-restricted game on the location-enabled gaming device 101, the location-restricted game application causes the mobile or wireless location-enabled gaming device 101 to contact the game server 102. The game server 102 receives rules from the policy server 104 to set, e.g., if the user's wireless location-enabled gaming device 101 must be in a given permissible geographic area 101a pre-defined for use of the given location-restricted game application attempting to be played on the wireless location-enabled gaming device 101.

The policy server 104 may also include definitions to define the permissible geographic area 101a, e.g., by Zip Code, etc.

The location server 103 securely obtains a current location of the wireless location-enabled gaming device 101, using otherwise known methods of locating a wireless device. Additionally, as a cross-check to the returned current location of a given wireless device, the location server 103 may request current location directly from the wireless location-enabled gaming device 101 itself. The location-enabled gaming device 101 may respond with a current location obtained from an on-board global positioning system (GPS) chipset.

The location server 103 sends this location information back to the requesting game server 102. The game server 102 determines whether or not the wireless location-enabled gaming device 101 attempting or requesting to play a given location-restricted game application is within a predefined permissible geographic area 101a in which the location-restricted game application is permitted to be played. Based on such a confirmation, the location-restricted game is then authorized and permitted to further present the next steps in the relevant location-enabled gaming device 101.

The policy server 104 preferably includes settings defining a required accuracy for a response to the location request. The accuracy can be, e.g., within 10 feet or meters, within 100 feet or meters, etc. Depending on the requested accuracy, the location server 103 can be requested to utilize different location technologies to obtain the requested location information.

Depending on the type of network that the wireless location-enabled gaming device 101 is operating in (e.g., GSM or CDMA), different location computing methods may be used to accurately determine the exact current location of the wireless location-restricted gaming device 101. For example, if the returned location accuracy is lower than a preset required threshold accuracy, the policy engine of the policy server 104 may indicate that the location-restricted game application can perform a user device-initiated location request, or can use an on-board GPS chip set, to determine its own geographic location.

Spoofing of the requested location information is preferably prevented with the use of a secure network.

If the user's wireless location-enabled gaming device 101 is not located within the authorized, permitted geographic area 101a for a given location-restricted game, the game server 102 determines that the relevant location-enabled gaming device 101 is not within the legal geographic area 101a in which it may legally operate (or is otherwise not permitted to operate.) In this case, the game server 102 will initiate a rejection of the gaming request and not permit operation of the location-restricted game application (e.g., not enabling the location-restricted game to be started) and/or otherwise causes termination of the location-restricted gaming program on the relevant location-enabled gaming device 101.

While the wireless location-enabled gaming device 101 is playing a given location-restricted game, a fresh location request may be triggered periodically, or intermittently, e.g., every configured interval, to validate that the relevant wireless location-enabled gaming device 101 remains within the authorized, legal geographical region in which it must to legally permit use of a given location-restricted gaming application. The periodically or intermittently triggered check of location of the relevant wireless location-enabled gaming device 101 preferably continues until the applicable location-restricted game terminates.

Any configurable gaming options for location-restricted games are preferably set via the policy server 104. For instance, the policy server 104 may include a configuration file that sets the level of the required accuracy of any returned geographic location to permit operation of a given location-restricted game.

Upon receipt of an indication that the wireless location-enabled gaming device 101 may have left the permissible geographic area 101a, operation of the location-restricted game may be paused at the location-enabled game server 102 for a period of time, until the location-enabled gaming device 101 is determined to be back within the permissible geographic area 101a. This permits smooth operation (with pauses in the game) as the location-enabled gaming device 101 skirts about the edge of a permissible geographic area 101a. The game parameters may be retained in place for a period of time (e.g., for 30 seconds, 1 minute, 5 minutes, or 10 minutes, etc.) after which it may be presumed that the location-enabled gaming device 101 has left the permissible geographic area 101a and the location-restricted game may be entirely terminated, in which case the temporary game-related parameters may be purged.

If an on-board GPS chip set on the wireless location-enabled gaming device 101 is used to compute the requested location of the wireless location-enabled gaming device 101, the result is preferably validated by intersection and correlation with current location results from a secure network-initiated location request. If the location results fall within the geographic area 101a in which the relevant location-restricted game is permitted to be played, the policy server 104 preferably permits the user's wireless location-enabled gaming device 101 to play the relevant location-restricted game.

If play or other operation of the location-restricted game is user-terminated at the wireless location-enabled gaming device 101, the game server 102 then ceases its periodic or intermittent location requests of that location-enabled gaming device 101.

The policy server 104 preferably records or otherwise maintains the last known state of the location-restricted game. This permits the location-restricted game operating on the wireless location-enabled gaming device 101 to be started again from the point at which the location-restricted game was at when the wireless location-enabled gaming device 101 last operated (e.g., to play in the same mode, from the same point in the game, where it was when it was last operated.)

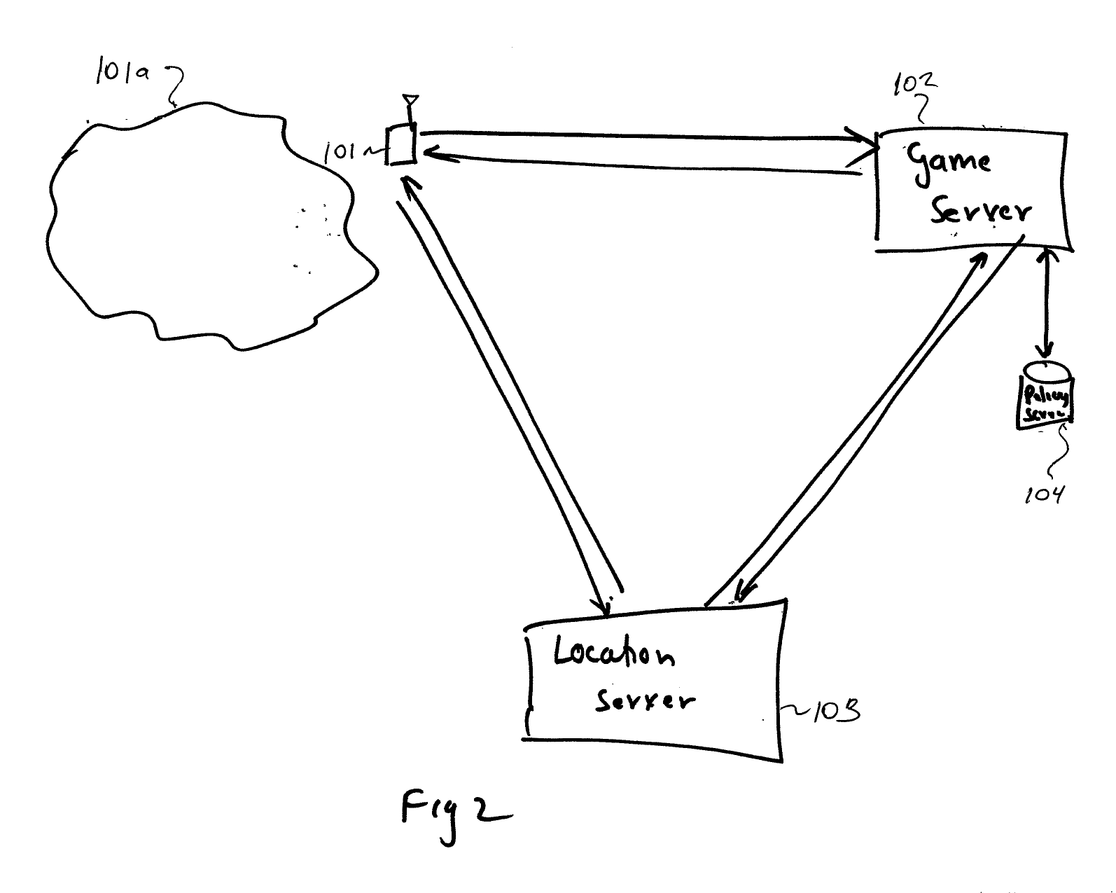

FIG. 2 shows exemplary message flow for a location-enabled gaming device operating a location-restricted game application, when the location-enabled gaming device is attempted to be operated when outside a permissible geographic area for the location-restricted game application to be played, in accordance with the principles of the present invention.

In particular, as shown in FIG. 2, in this case the game server 102 provides an update indicating that the wireless location-enabled gaming device 101 cannot play the given location-restricted gaming application because the wireless location-enabled gaming device 101 is outside the authorized or otherwise permissible geographic area 101a.

The invention has particular use and applicability to mobile gaming operable on cellular phones, voice over Internet protocol (VoIP) wireless devices, smart phones, and other hand held wireless phone devices.

While the invention has been described with reference to the exemplary embodiments thereof, those skilled in the art will be able to make various modifications to the described embodiments of the invention without departing from the true spirit and scope of the invention.

What is claimed is:

1. A method of administering a location-restricting game application over a network, comprising:
receiving a game-initiation request from a gaming device requesting participation in a location-restricted game application;
in response to receipt of said game-initiation request, requesting a current location of said gaming device;
determining if said gaming device is currently within an authorized geographic area in which said requested game may be permissibly played; and
if said gaming device is within said authorized geographic area, authorizing said game-initiation request.

2. The method of administering a location-restricting game application over a network according to claim 1, wherein:
said authorized geographic area is a state.

3. The method of administering a location-restricting game application over a network according to claim 1, wherein:
said gaming device is a wireless gaming device.

4. The method of administering a location-restricting game application over a network according to claim 3, wherein:
said wireless gaming device is a wireless phone.

5. The method of administering a location-restricting game application over a network according to claim 1, further comprising:
requesting location information from said gaming device.

6. The method of administering a location-restricting game application over a network according to claim 5, wherein:
said location information is obtained from a satellite positioning system receiver on said gaming device.

7. The method of administering a location-restricting game application over a network according to claim 1, further comprising:
intermittently triggering a request for a fresh current geographic location of an active game participating wireless device.

8. The method of administering a location-restricting game application over a network according to claim 1, wherein said gaming device comprises:
a smartphone.

9. Apparatus for administering a location-restricting game application over a network, comprising:
means for receiving a game-initiation request from a gaming device requesting participation in a location-restricted game application;
means for requesting a current location of said gaming device in response to receipt of said game-initiation request;
means for determining if said gaming device is currently within an authorized geographic area in which said requested game may be permissibly played; and
means for authorizing said game-initiation request if said gaming device is within said authorized geographic area.

10. The apparatus for administering a location-restricting game application over a network according to claim 9, wherein:
said authorized geographic area is a state.

11. The apparatus for administering a location-restricting game application over a network according to claim 9, wherein:
said gaming device is a wireless gaming device.

12. The apparatus for administering a location-restricting game application over a network according to claim 11, wherein:
said wireless gaming device is a wireless phone.

13. The apparatus for administering a location-restricting game application over a network according to claim 9, further comprising:
means for requesting location information from said gaming device.

14. The apparatus for administering a location-restricting game application over a network according to claim 13, wherein:
said location information is obtained from a satellite positioning system receiver on said gaming device.

15. The apparatus for administering a location-restricting game application over a network according to claim 9, further comprising:
means for intermittently triggering a request for a fresh current geographic location of an active game participating wireless device.

16. The apparatus for administering a location-restricting game application over a network according to claim 9, wherein said gaming device comprises:
a smartphone.
